(19) United States
(12) Patent Application Publication
(10) Pub. No.: US 2022/0080949 A1
(43) Pub. Date: Mar. 17, 2022

(54) HYBRID VEHICLE

(71) Applicant: TOYOTA JIDOSHA KABUSHIKI KAISHA, Toyota-shi Aichi-ken (JP)

(72) Inventors: Taiga Hagimoto, Mishima-shi (JP); Takashi Iwata, Susono-shi (JP)

(21) Appl. No.: 17/473,132

(22) Filed: Sep. 13, 2021

(30) Foreign Application Priority Data
Sep. 14, 2020 (JP) 2020-154106

(51) Int. Cl. B60W 20/20; B60W 10/06; B60W 10/08; B60W 10/26; B60W 20/40; H02M 7/797; H02J 7/24

(52) U.S. Cl. CPC B60W 20/20; B60W 10/06; B60W 10/08; B60W 10/26; B60W 2510/0676; H02M 7/797; H02J 7/24; B60W 2520/00; B60W 20/40

(57) ABSTRACT

A hybrid vehicle includes: a power generation device including an engine, a first rotating electric machine, and a first inverter; a drive device including a second rotating electric machine that outputs driving force, and a second inverter; an electric storage device that exchanges electric power with the power generation device and the drive device; a switching device that switches electrical connection of the electric storage device and the power generation device between parallel connection and series connection; and a control device that at least controls the switching device. Further, the control device controls the switching device in such a manner as to switch the electric storage device and the power generation device from the parallel connection to the series connection in a case where a combination of a vehicle speed and driving force satisfies a predetermined condition while the hybrid vehicle is traveling.

### CROSS-REFERENCE TO RELATED APPLICATION(S)

The present application claims priority to and incorporates by reference the entire contents of Japanese Patent Application No. 2020-154106 filed in Japan on Sep. 14, 2020.

### BACKGROUND

The present disclosure relates to a hybrid vehicle.

In Japanese Patent No. 6403922, a hybrid vehicle that includes a power generation device having an engine, a power generation motor, and an inverter, a battery, a drive device having a drive motor and an inverter, and a switching device that switches series connection and parallel connection of the battery and the power generation device with respect to the drive device is disclosed. In the hybrid vehicle disclosed in Japanese Patent No. 6403922, the parallel connection and the series connection of the battery and the power generation device are switched when the engine is operated while the vehicle is traveling. Then, by switching the battery and the power generation device to the series connection, it becomes possible to increase voltage of electric power supplied to the drive device and to increase driving force output from the drive motor compared to a case of the parallel connection.

### SUMMARY

There is a need for providing a hybrid vehicle capable of effectively performing switching between parallel connection and series connection of an electric storage device and a power generation device.

According to an embodiment, a hybrid vehicle includes: a power generation device including an engine, a first rotating electric machine capable of generating electric power by using power from the engine, and a first inverter capable of converting an AC voltage and a DC voltage with the first rotating electric machine; a drive device including a second rotating electric machine that outputs driving force to drive a drive wheel, and a second inverter capable of converting an AC voltage and a DC voltage with the second rotating electric machine; an electric storage device that exchanges electric power with the power generation device and the drive device; a switching device that switches electrical connection of the electric storage device and the power generation device between parallel connection and series connection with respect to the drive device; and a control device that at least controls the switching device. Further, the control device controls the switching device in such a manner as to switch the electric storage device and the power generation device from the parallel connection to the series connection in a case where a combination of a vehicle speed and driving force satisfies a predetermined condition while the hybrid vehicle is traveling.

### BRIEF DESCRIPTION OF THE DRAWINGS

FIG. 1 is a view schematically illustrating a configuration of a hybrid vehicle according to an embodiment;

FIG. 2 is a view illustrating an example of a circuit configuration related to a power generation device and a drive device in the hybrid vehicle according to the embodiment;

FIG. 3 is a view illustrating a circuit state of a case where a battery and the power generation device are connected in parallel;

FIG. 4 is a view illustrating a circuit state of a case where the battery and the power generation device are connected in series;

FIG. 5 is a flowchart illustrating an example of switching control of performing switching between parallel connection and series connection of the battery and the power generation device in the embodiment;

FIG. 6 is a view illustrating a circuit state of a case where the battery and the power generation device are connected in parallel when an engine is started;

FIG. 7 is a view illustrating a circuit state of a case where the battery and the power generation device are connected in series when the engine is started;

FIG. 8 is a view illustrating a circuit state of a case where the battery and the power generation device are connected in parallel when the battery is charged by power generation by a power generation motor and a drive motor;

FIG. 9 is a view illustrating a circuit state of a case where the battery and the power generation device are connected in series when the battery is charged by power generation by the power generation motor and the drive motor;

FIG. 10 is a view for describing a predetermined condition for a combination of a vehicle speed and driving force in a first example;

FIG. 11 is a flowchart illustrating an example of switching control of performing switching between parallel connection and series connection of a battery and a power generation device in the first example;

FIG. 12 is a view for describing a predetermined condition for a combination of a vehicle speed and driving force in a second example; and

FIG. 13 is a flowchart illustrating an example of switching control of performing switching between parallel connection and series connection of a battery and a power generation device in the second example.

### DETAILED DESCRIPTION OF THE PREFERRED EMBODIMENTS

In the related art, as a hybrid vehicle, a so-called series hybrid vehicle in which an engine is not used as a driving force source for traveling and in which electric power is supplied from at least one of a power generation device and a battery to drive a drive motor and to perform traveling has been known. While the series hybrid vehicle is traveling, engine operation and an engine stop are performed, for example. Thus, in order to effectively perform switching between parallel connection and series connection of a battery and a power generation device, there is room for improvement such as increasing driving force output from a drive motor at appropriate timing during vehicle traveling including not only when an engine is operating as in the hybrid vehicle disclosed in Japanese Patent No. 6403922 but also when the engine is stopped.

In the following, an embodiment of a control device of a vehicle according to the present disclosure will be described. Note that the present disclosure is not limited to the present embodiment.

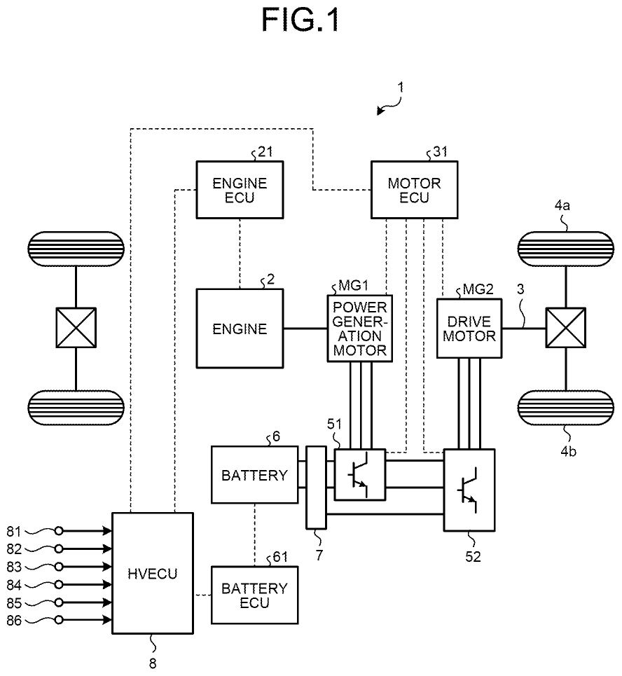

FIG. 1 is a view schematically illustrating a configuration of a hybrid vehicle 1 according to an embodiment. In the hybrid vehicle 1, a power generation motor MG1 that is a first rotating electric machine is connected to an output shaft of an engine 2, and drive wheels 4a and 4b are coupled via a drive shaft 3 to a drive motor MG2 that is a second rotating electric machine. This hybrid vehicle 1 includes the engine 2, the power generation motor MG1, the drive motor MG2, inverters 51 and 52, a battery 6 that is an electric storage device, a switching device 7, an HVECU 8 that is an electronic control device for hybrid traveling, and the like.

The engine 2 includes a known internal combustion engine. Also, a catalyst to purify exhaust gas is provided in an exhaust path of the engine 2. That is, the hybrid vehicle 1 includes a catalytic converter that purifies the exhaust gas with a three-way catalyst. The engine 2 is controlled by an engine ECU 21 that is an electronic control device for the engine.

The engine ECU 21 includes a microprocessor, and has a CPU, ROM, RAM and the like. The engine ECU 21 is communicably connected to the HVECU 8, and controls the engine 2 on the basis of a command signal input from the HVECU 8. For example, the engine ECU 21 controls fuel injection and ignition timing with respect to the engine 2.

Each of the power generation motor MG1 and the drive motor MG2 includes a motor generator. The power generation motor MG1 is driven by the engine 2 and functions as a power generator. A rotor of the power generation motor MG1 is connected to the output shaft of the engine 2, and the power generation motor MG1 generates electric power by power output from the engine 2. The drive motor MG2 functions as an electric motor for traveling which electric motor is driven by electric power of the battery 6. A rotor of the drive motor MG2 is connected to the drive shaft 3, and the drive motor MG2 is driven by the electric power of the battery 6. The inverters 51 and 52 are electrically connected to the power generation motor MG1 and the drive motor MG2, and are also electrically connected to the battery 6. The power generation motor MG1 is electrically connected to the drive motor MG2 via the inverters 51 and 52. Also, the power generation motor MG1 and the drive motor MG2 are controlled by a motor ECU 31 that is an electronic control device for a motor.

The motor ECU 31 includes a microprocessor similar to that of the engine ECU 21. This motor ECU 31 is communicably connected to the HVECU 8. For example, the motor ECU 31 controls the power generation motor MG1 and the drive motor MG2 by performing switching control of a plurality of switching elements included in the inverters 51 and 52 on the basis of the command signal input from the HVECU 8. More specifically, the motor ECU 31 executes control of simultaneously causing the power generation motor MG1 to function as a power generator and causing the drive motor MG2 to function as an electric motor (power running control). Also, the motor ECU 31 executes control of simultaneously causing the power generation motor MG1 to function as a power generator and to generate electric power and causing the drive motor MG2 to function as a power generator and to generate electric power (regenerative control). Furthermore, the motor ECU 31 executes control of causing the drive motor MG2 to function as a power generator and to generate electric power while minimizing a power generation amount in the power generation motor MG1 or without generating electric power in the power generation motor MG1.

The battery 6 includes a secondary battery such as a lithium-ion battery or a nickel-hydrogen battery. Also, the battery 6 is electrically connected to the inverters 51 and 52. This battery 6 is controlled by a battery ECU 61 that is an electronic control device for the battery.

The battery ECU 61 includes a microprocessor, and is communicably connected to the HVECU 8. This battery ECU 61 manages a state of charge (SOC) of the battery 6.

The HVECU 8 includes a microprocessor, and controls the hybrid vehicle 1. Signals from various sensors are input into the HVECU 8. The signals input into the HVECU 8 include an engine speed signal from an engine speed sensor 81 that detects a rotation speed of the engine 2, an accelerator position signal from an accelerator position sensor 82 that detects an amount of depression of an accelerator pedal, a brake pedal position signal from a brake stroke sensor 83 that detects an amount of depression of a brake pedal, a vehicle speed signal from a vehicle speed sensor 84, an SOC signal from an SOC sensor 85 that detects an SOC of the battery 6, a water temperature signal from a water temperature sensor 86 that detects a temperature of cooling water that cools the engine 2 (water temperature in the engine 2), and the like. Then, the HVECU 8 can output command signals to the engine ECU 21, the motor ECU 31, and the battery ECU 61 as a result of various calculations. The control device of the hybrid vehicle 1 in the embodiment includes at least the HVECU 8 among the HVECU 8, the engine ECU 21, the motor ECU 31, and the battery ECU 61.

Also, the HVECU 8 executes SOC control to manage the SOC of the battery 6 within a range of battery charging capacity. For example, the HVECU 8 and the battery ECU 61 can detect an actual SOC, which is an actual SOC of the battery 6, on the basis of the SOC signal input from the SOC sensor 85 to the HVECU 8. Then, the HVECU 8 manages a power balance between a power generation amount in the power generation motor MG1 and a power consumption in the drive motor MG2 according to a traveling state of the hybrid vehicle 1, and controls the SOC within a range of the battery charging capacity in such a manner as to prevent overcharge and overdischarge of the battery 6.

The hybrid vehicle 1 according to the embodiment is a so-called range extender hybrid vehicle, and has an electric traveling mode and a series hybrid traveling mode. The electric traveling mode is a mode of driving the drive motor MG2 by the electric power from the battery 6 and performing traveling without an operation of the engine 2, for example, in a case where the SOC of the battery 6 is a predetermined value or larger. The series hybrid traveling mode is a mode of causing the engine 2 to operate and the power generation motor MG1 to generate electric power, supplying the electric power from the power generation motor MG1 to the drive motor MG2 directly or via the battery 6, and driving the drive motor MG2 and performing traveling, for example, in a case where the SOC of the battery 6 becomes smaller than the predetermined value, or in a case where required driving force cannot be output to the drive motor MG2 only with the electric power from the battery 6.

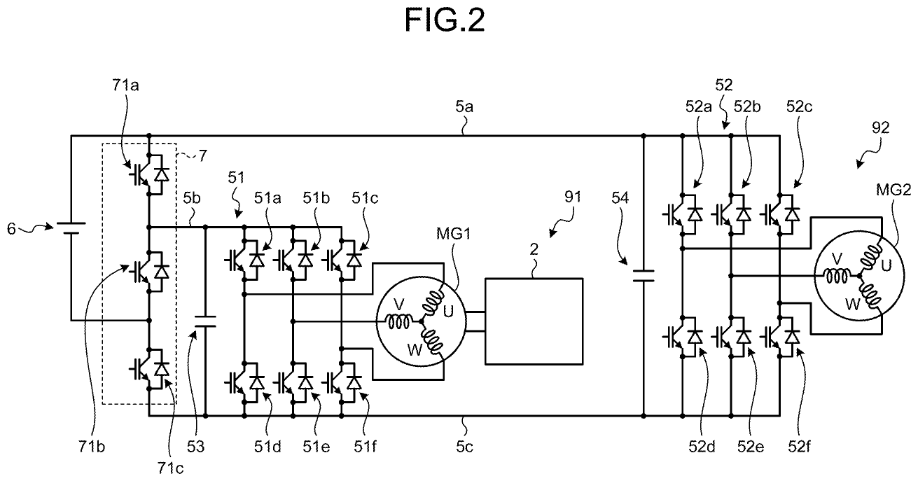

FIG. 2 is a view illustrating an example of a circuit configuration related to a power generation device 91 and a drive device 92 in the hybrid vehicle 1 according to the embodiment.

In the hybrid vehicle 1 according to the embodiment, the power generation device 91 includes the engine 2, the power generation motor MG1, the inverter 51, and the like. In the power generation device 91, the inverter 51 is connected to the battery 6 via the switching device 7.

The inverter 51 as a first inverter includes an upper arm to which a positive electrode-side voltage is supplied, and a lower arm to which a negative electrode-side voltage is supplied. In the inverter 51, the upper arm to which the positive electrode-side voltage is supplied and the lower arm to which the negative electrode-side voltage is supplied are arranged in series between a positive electrode-side power line 5b and a negative electrode-side power line 5c, and conversion between a three-phase AC voltage and DC voltage can be performed with the power generation motor MG1. Also, the inverter 51 includes a U-phase arm to exchange a U-phase voltage with a U-phase coil of the power generation motor MG1, a V-phase arm to exchange a V-phase voltage with a V-phase coil of the power generation motor MG1, and a W-phase arm to exchange a W-phase voltage with a W-phase coil of the power generation motor MG1.

In the U-phase arm, a switching element 51a and a switching element 51d are connected in series between the positive electrode-side power line 5b and the negative electrode-side power line 5c. Also, the U-phase coil of the power generation motor MG1 is connected to a connection point at which the switching element 51a and the switching element 51d are connected. In the V-phase arm, a switching element 51b and a switching element 51e are connected in series between the positive electrode-side power line 5b and the negative electrode-side power line 5c. Also, the V-phase coil of the power generation motor MG1 is connected to a connection point at which the switching element 51b and the switching element 51e are connected. In the W-phase arm, a switching element 51c and a switching element 51f are connected in series between the positive electrode-side power line 5b and the negative electrode-side power line 5c. Also, the W-phase coil of the power generation motor MG1 is connected to a connection point at which the switching element 51c and the switching element 51f are connected.

Then, for example, when voltage is applied to the inverter 51, a ratio of ON time of the switching elements 51a to 51f respectively paired in the U-phase arm, the V-phase arm, and the W-phase arm is adjusted by the motor ECU 31. Thus, a rotating magnetic field is formed in the three-phase coil of the power generation motor MG1, and the power generation motor MG1 is rotationally driven.

The power generation motor MG1 functions as a motor when the DC voltage output from the battery 6 is converted into the three-phase AC voltage by the inverter 51 and supplied, and generates driving force for cranking when the engine 2 is started. Also, the power generation motor MG1 is driven by the engine 2 and generates electric power, and outputs a three-phase AC voltage. Then, this three-phase AC voltage is converted into a DC voltage by the inverter 51, charges the battery 6 when supplied to the battery 6, and drives the drive motor MG2 when supplied to the inverter 52.

Also, in parallel with the inverter 51, one terminal of a smoothing capacitor 53 is connected to the positive electrode-side power line 5b, and the other terminal thereof is connected to the negative electrode-side power line 5c.

In the hybrid vehicle 1 according to the embodiment, the drive device 92 to rotationally drive the drive wheels 4a and 4b includes the inverter 52, the drive motor MG2 and the like. In the drive device 92, the inverter 52 is connected to the battery 6 via the switching device 7.

The inverter 52 as a second inverter includes an upper arm to which a positive electrode-side voltage is supplied, and a lower arm to which a negative electrode-side voltage is supplied. In the inverter 52, the upper arm to which the positive electrode-side voltage is supplied and the lower arm to which the negative electrode-side voltage is supplied are arranged in series between a positive electrode-side power line 5a and the negative electrode-side power line 5c, and conversion between a three-phase AC voltage and DC voltage can be performed with the drive motor MG2. Also, the inverter 52 has a U-phase arm to exchange a U-phase voltage with a U-phase coil of the drive motor MG2, a V-phase arm to exchange a V-phase voltage with a V-phase coil of the drive motor MG2, and a W-phase arm to exchange a W-phase voltage with a W-phase coil of the drive motor MG2.

In the U-phase arm, a switching element 52a and a switching element 52d are connected in series between the positive electrode-side power line 5a and the negative electrode-side power line 5c. Also, the U-phase coil of the drive motor MG2 is connected to a connection point at which the switching element 52a and the switching element 52d are connected. In the V-phase arm, a switching element 52b and a switching element 52e are connected in series between the positive electrode-side power line 5a and the negative electrode-side power line 5c. Also, the V-phase coil of the drive motor MG2 is connected to a connection point at which the switching element 52b and the switching element 52e are connected. In the W-phase arm, a switching element 52c and a switching element 52f are connected in series between the positive electrode-side power line 5a and the negative electrode-side power line 5c. Also, the W-phase coil of the drive motor MG2 is connected to a connection point at which the switching element 52c and the switching element 52f are connected.

Then, for example, when voltage is applied to the inverter 52, a ratio of ON time of the switching elements 52a to 52f respectively paired in the U-phase arm, the V-phase arm, and the W-phase arm is adjusted by the motor ECU 31. Thus, a rotating magnetic field is formed in the three-phase coil of the drive motor MG2, and the drive motor MG2 is rotationally driven.

The drive motor MG2 functions as a motor when the DC voltage output from the battery 6 or the like is converted into a three-phase AC voltage by the inverter 52 and supplied, and generates driving force to cause the hybrid vehicle 1 to travel. On the one hand, the drive motor MG2 functions as a power generator by regeneration when the hybrid vehicle 1 is braked, recovers braking energy, and outputs the energy as a three-phase AC voltage. Then, this three-phase AC voltage is converted into a DC voltage by the inverter 52 and supplied to the battery 6, whereby the battery 6 is charged.

Also, in parallel with the inverter 52, one terminal of a smoothing capacitor 54 is connected to the positive electrode-side power line 5a, and the other terminal thereof is connected to the negative electrode-side power line 5c.

In the switching device 7, a switching element 71a, a switching element 71b, and a switching element 71c are connected in series between the positive electrode-side power line 5a and the negative electrode-side power line 5c. Also, a positive electrode-side terminal of the battery 6 is connected to one terminal of the switching element 71a, and a negative electrode-side terminal of the battery 6 is connected to a connection point at which the switching element 71b and the switching element 71c are connected.

Then, by being controlled by the HVECU 8, the switching device 7 switches each of the switching element 71a, the switching element 71b, and the switching element 71c between ON (energized state) and OFF (disconnected state), and switches electrical connection of the battery 6 and the power generation device 91 (inverter 51) between parallel connection and series connection as viewed from the drive device 92.

Note that in the present embodiment, an insulated gate bipolar transistor (IGBT) or the like can be used as a semiconductor element with respect to each of the switching elements 51a to 51f, the switching elements 52a to 52f, and the switching elements 71a to 71c. Also, each of the switching elements 51a to 51f, the switching elements 52a to 52f, and the switching elements 71a to 71c has a configuration in which a freewheeling diode is in an antiparallel manner with respect to the semiconductor element. For example, the antiparallel manner means that a cathode terminal of the diode is connected to a collector terminal of the semiconductor element and an anode terminal of the diode is connected to an emitter terminal of the semiconductor element.

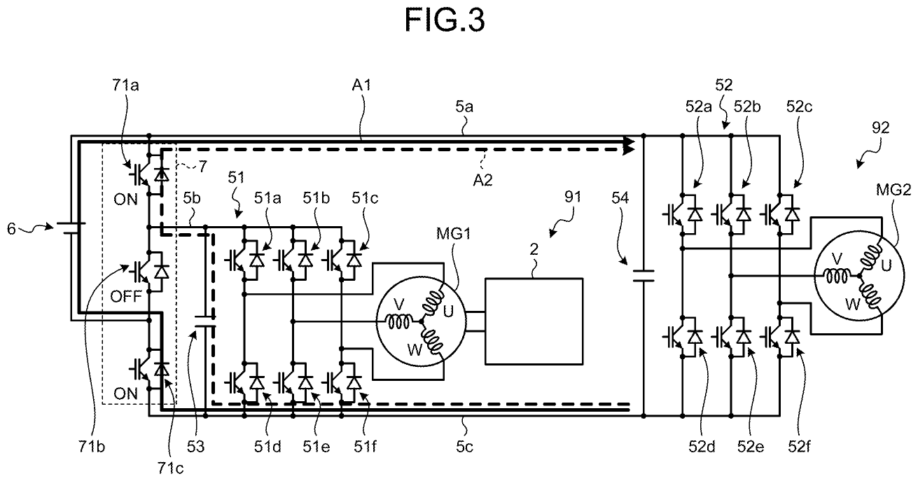

FIG. 3 is a view illustrating a circuit state of a case where the battery 6 and the power generation device 91 are connected in parallel. Note that in FIG. 3, an arrow A1 indicates a part of a flow of current from the battery 6. Also, in FIG. 3, an arrow A2 indicates a part of a flow of current from the power generation device 91.

As illustrated in FIG. 3, in a case where the battery 6 and the power generation device 91 are connected in parallel, the HVECU 8 controls the switching device 7 in such a manner that the switching element 71a and the switching element 71c are turned on and the switching element 71b is turned off. As a result, the battery 6 and the power generation device 91 are connected in parallel in such a manner that current flows in a circuit in a manner indicated by the arrows A1 and A2 in FIG. 3.

In a case where the battery 6 and the power generation device 91 are connected in parallel, when electric power is supplied from both of the battery 6 and the power generation device 91 to the drive device 92, a DC voltage (battery voltage) of the battery 6 and a DC voltage of the power generation device 91 become equal voltage. That is, in a case where the battery 6 and the power generation device 91 are connected in parallel, electric power having a voltage equal to the battery voltage can be supplied to the drive device 92.

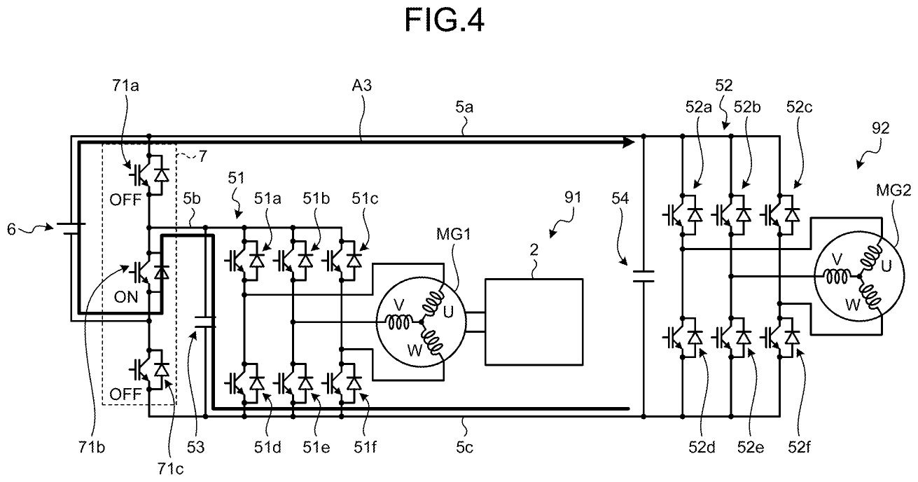

FIG. 4 is a view illustrating a circuit state of a case where the battery 6 and the power generation device 91 are connected in series. Note that in FIG. 4, an arrow A3 indicates a part of a flow of current in which current from the battery 6 and current from the power generation device 91 are combined.

As illustrated in FIG. 4, in a case where the battery 6 and the power generation device 91 are connected in series, the HVECU 8 controls the switching device 7 in such a manner that the switching element 71b is turned on and the switching element 71a and the switching element 71c are turned off. As a result, the battery 6 and the power generation device 91 are connected in series in such a manner that the current flows in the circuit as indicated by the arrow A3 in FIG. 4.

In a case where the battery 6 and the power generation device 91 are connected in series, when electric power is supplied from both of the battery 6 and the power generation device 91 to the drive device 92, electric power of a voltage having a value that is the sum of the DC voltage (battery voltage) of the battery 6 and the DC voltage of the power generation device 91 is supplied to the drive device 92. That is, in a case where the battery 6 and the power generation device 91 are connected in series, electric power having a voltage higher than the battery voltage can be supplied to the drive device 92.

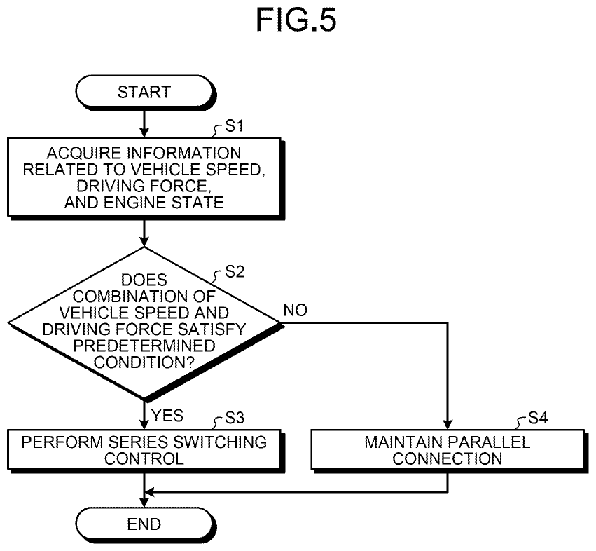

FIG. 5 is a flowchart illustrating an example of switching control of performing switching between parallel connection and series connection of the battery 6 and the power generation device 91 in the embodiment. Note that it is assumed that the switching control illustrated in FIG. 5 is started from a state in which the battery 6 and the power generation device 91 are connected in parallel.

First, the HVECU 8 acquires information related to a vehicle speed, driving force, and an engine state from signals input from various sensors (Step S1). Note that the engine state includes, for example, whether the engine 2 is in operation, whether the engine 2 is stopped, whether the engine 2 is at a low temperature and the like. Then, the HVECU 8 determines whether a combination of the vehicle speed and the driving force satisfies a predetermined condition (Step S2). In a case of determining that the combination of the vehicle speed and the driving force satisfies the predetermined condition (Yes in Step S2), the HVECU 8 performs series switching control, switches the battery 6 and the power generation device 91 to the series connection by the switching device 7 (Step S3), and ends the series of control. On the one hand, in a case of determining that the combination of the vehicle speed and the driving force does not satisfy the predetermined condition (No in Step S2), the HVECU 8 maintains the parallel connection between the battery 6 and the power generation device 91 (Step S4), and ends the series of control. Note that the predetermined condition for the combination of the vehicle speed and the driving force which condition is used for the determination in Step S2 will be described later.

In the hybrid vehicle 1 according to the embodiment, the battery 6 and the power generation device 91 are switched from the parallel connection to the series connection in a case where the combination of the vehicle speed and driving force satisfies the predetermined condition while the vehicle is traveling. Thus, in the hybrid vehicle 1 according to the embodiment, it is possible to effectively perform switching between the parallel connection and the series connection of the battery 6 and the power generation device 91 at appropriate timing while the vehicle is traveling not only when the engine is operating but also when the engine is stopped.

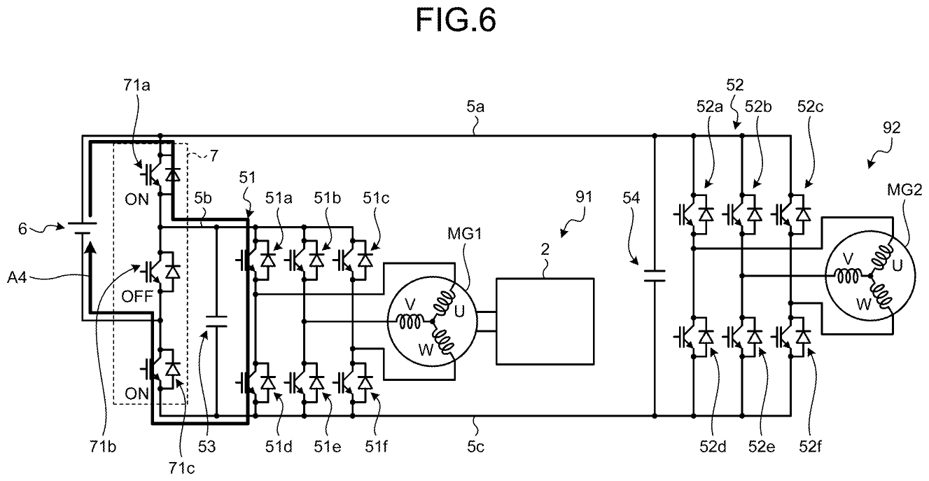

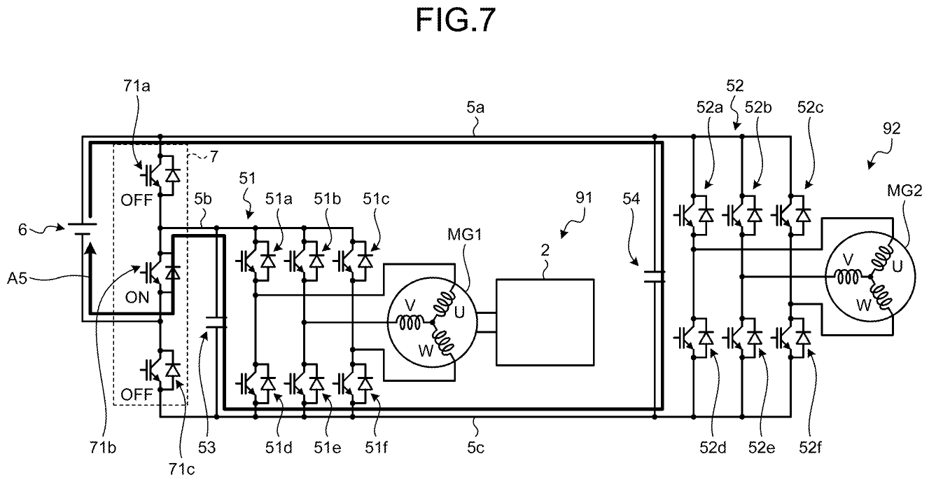

FIG. 6 is a view illustrating a circuit state of a case where the battery 6 and the power generation device 91 are connected in parallel when the engine is started. FIG. 7 is a view illustrating a circuit state of a case where the battery 6 and the power generation device 91 are connected in series when the engine is started.

In the hybrid vehicle 1 according to the embodiment, when the engine 2 is started, the battery 6 and the power generation device 91 are connected in parallel, electric power is supplied to the power generation motor MG1 from the battery 6 via the inverter 51 as a flow of current being indicated by an arrow A4 in FIG. 6, and the power generation motor MG1 is driven to crank the engine 2.

On the one hand, in the hybrid vehicle 1 according to the embodiment, when the battery 6 and the power generation device 91 are connected in series when the engine 2 is started, as a flow of current being indicated by an arrow A5 in FIG. 7, it is not possible to flow electric current, which is to rotate the power generation motor MG1, in a direction of cranking the engine 2 from the battery 6 to the power generation motor MG1 via the inverter 51. Thus, in the hybrid vehicle 1 according to the embodiment, when the battery 6 and the power generation device 91 are connected in series when the engine is started, the power generation motor MG1 cannot crank the engine 2 and the engine 2 cannot be started.

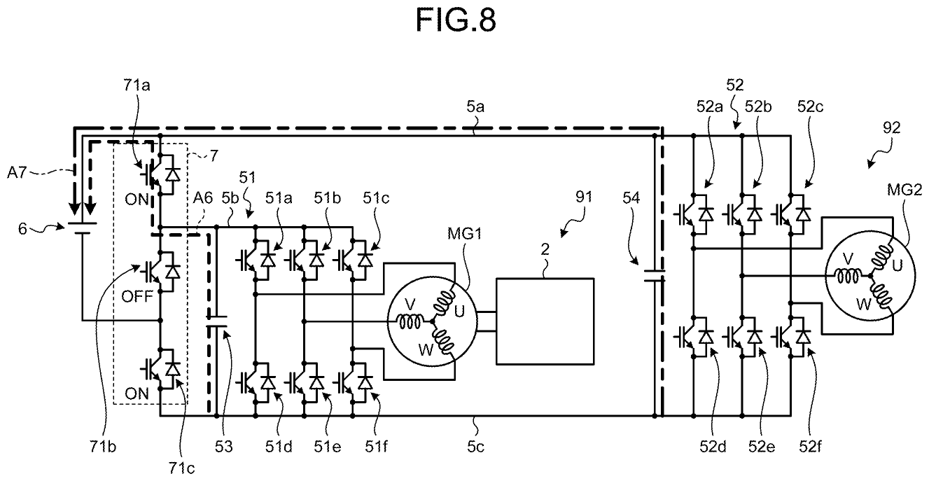

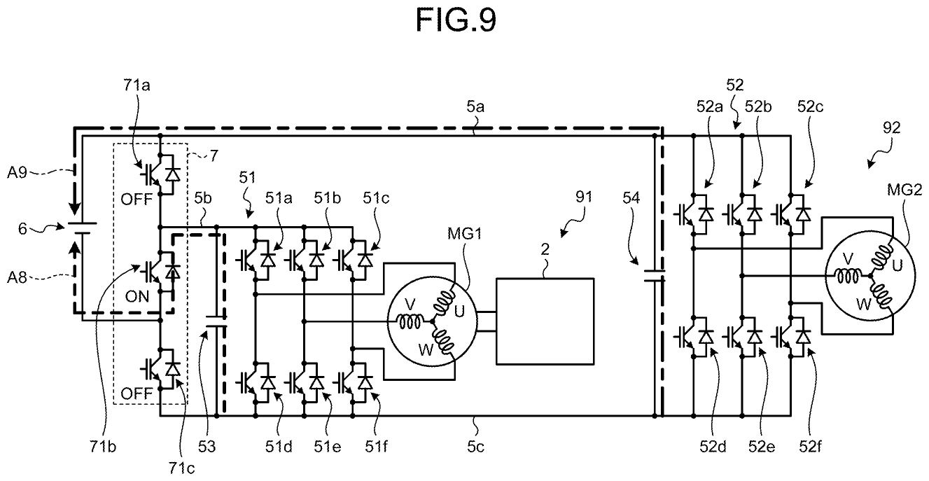

FIG. 8 is a view illustrating a circuit state of a case where the battery 6 and the power generation device 91 are connected in parallel when the battery 6 is charged by power generation by the power generation motor MG1 and the drive motor MG2. FIG. 9 is a view illustrating a circuit state of a case where the battery 6 and the power generation device 91 are connected in series when the battery 6 is charged by power generation by the power generation motor MG1 and the drive motor MG2.

In the hybrid vehicle 1 according to the embodiment, when the battery 6 is charged by the power generation by the power generation motor MG1 and the drive motor MG2, the battery 6 and the power generation device 91 are connected in parallel, and current is made to flow from the power generation motor MG1 and the drive motor MG2 toward the positive electrode-side terminal of the battery 6 via the inverter 51 and the inverter 52 to supply electric power to the battery 6 as indicated by arrows A6 and A7 in FIG. 8.

On the one hand, in the hybrid vehicle 1 according to the embodiment, when the battery 6 and the power generation device 91 are connected in series when the battery 6 is charged by the power generation by the power generation motor MG1 and the drive motor MG2, a direction of current flowing in the circuit becomes opposite with respect to the battery 6. That is, current flows from the power generation motor MG1 toward the positive electrode-side terminal of the battery 6 via the inverter 51 as indicated by an arrow A8 in FIG. 9, and current flows from the drive motor MG2 toward the negative electrode-side terminal of the battery 6 via the inverter 52 as indicated by an arrow A9 in FIG. 9. Thus, in the hybrid vehicle 1 according to the embodiment, when the battery 6 and the power generation device 91 are connected in series when the battery 6 is charged by the power generation by the power generation motor MG1 and the drive motor MG2, the circuit is not electrically established and the battery 6 cannot be charged.

In such a manner, since there are electrical restrictions on the circuit in the hybrid vehicle 1 according to the embodiment, the battery 6 and the power generation device 91 are usually kept in a state of being connected in parallel. Thus, in the hybrid vehicle 1 according to the embodiment, for example, switching determination to determine whether to switch the battery 6 and the power generation device 91 from the parallel connection to the series connection becomes necessary during traveling.

### First Example

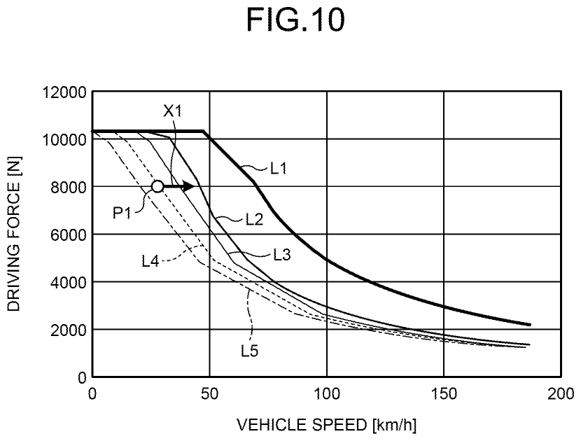

FIG. 10 is a view for describing a predetermined condition for a combination of a vehicle speed and driving force in a first example. Note that a series switching determination line indicates a relationship between a vehicle speed and driving force, which relationship is a determination criterion for switching the battery 6 and the power generation device 91 to series connection, and is set by a map for the vehicle speed and the driving force. L1 in FIG. 10 indicates a maximum driving force line indicating, with respect to a vehicle speed, maximum driving force that can be output by the drive motor MG2 when the battery 6 and the power generation device 91 are connected in series. Also, L2 in FIG. 10 indicates a maximum driving force line indicating, with respect to a vehicle speed, maximum driving force that can be output by the drive motor MG2 when the battery 6 and the power generation device 91 are connected in parallel.

In the first example, a plurality of series switching determination lines used as determination criteria for switching the battery 6 and the power generation device 91 from the parallel connection to the series connection according to the vehicle speed and the driving force is included according to states of the engine 2. Then, in the first example, as a predetermined condition for a combination of the vehicle speed and the driving force, when a current vehicle speed and driving force exceed a predetermined series switching determination line selected from the plurality of series switching determination lines according to a state of the engine 2, series switching control of switching the battery 6 and the power generation device 91 to the series connection is performed.

As the plurality of series switching determination lines according to the state of the engine 2, for example, there are a series switching determination line L3 of when the engine is operating, a series switching determination line L4 of when the engine is stopped, a series switching determination line L5 of when the engine is stopped and is at a low temperature, and the like illustrated in FIG. 10.

The series switching determination line L3 of when the engine is operating indicates a relationship between the vehicle speed and the driving force which relationship is used as a determination criterion for switching the battery 6 and the power generation device 91 to the series connection when the engine is operating. Also, the series switching determination line L4 of when the engine is stopped indicates a relationship between the vehicle speed and the driving force which relationship is used as a determination criterion for switching the battery 6 and the power generation device 91 to the series connection when the engine is stopped. Also, the series switching determination line L5 of when the engine is stopped and is at a low temperature indicates a relationship between the vehicle speed and the driving force which relationship is used as a determination criterion for switching the battery 6 and the power generation device 91 to the series connection when the engine is stopped and the engine 2 is at a low temperature that is lower than a predetermined temperature.

Here, it takes time TR after the switching device 7 starts switching the battery 6 and the power generation device 91 to the series connection until it becomes possible to supply electric power to the drive device 92 from the battery 6 and the power generation device 91 in the series connection. Thus, in the first example, when it is assumed that current required driving force is maintained, a series switching determination line used as a determination criterion is determined in such a manner that the required driving force does not exceed the maximum driving force line L2, which can be output from the drive motor MG2 in the parallel connection, before the time TR elapses.

For example, when the battery 6 and the power generation device 91 are connected in parallel and “required driving force>driving force that can be output from the drive motor MG2” is satisfied, the battery 6 and the power generation device 91 are switched to the series connection. Here, it takes the time TR before it becomes possible to supply electric power from the battery 6 and the power generation device 91 to the drive device 92. That is, time such as a delay in switching between the parallel connection and the series connection by switching operation of the switching elements 71a to 71c in the switching device 7, or a delay until the engine 2 is cranked by the power generation motor MG1 and the engine 2 is started when the engine 2 is stopped is necessary. Then, when the required driving force reaches the maximum driving force line L2 before the time TR elapses, only electric power having a voltage equal to the battery voltage can be supplied to the drive device 92 from the time point until the time TR elapses. Thus, the drive motor MG2 cannot output the required driving force, and the driving force becomes insufficient.

Thus, in the first example, the plurality of series switching determination lines that is the series switching determination line L3 of when the engine is operating, the series switching determination line L4 of when the engine is stopped, and a series switching determination line L5 of when the engine is stopped and is at a low temperature is included according to magnitude of the required driving force. Then, in the first example, each of the series switching determination lines, which are the series switching determination line L3 of when the engine is operating, the series switching determination line L4 of when the engine is stopped, and the series switching determination line L5 of when the engine is stopped and is at a low temperature, to be used for the series switching control is determined according to the magnitude of the required driving force.

Also, when the engine is operating, the time TR required for the series switching control is only time T1 necessary for switching of the battery 6 and the power generation device 91 from the parallel connection to the series connection. On the one hand, when the engine is stopped, the time TR required for the series switching control is time that is the sum of the time T1 and time T2 necessary to start the engine 2 (T1+T2). Also, when the engine is at a low temperature, the start of the engine 2 is delayed. Thus, when the engine is stopped and the engine is at the low temperature, the time TR required for the series switching control is time that is the sum of the time T1 and time T3 (>T2) necessary to start the engine 2 when the engine is at the low temperature (T1+T3).

Thus, in the first example, in consideration that the time TR required for the series switching control varies depending on a state of the engine 2, a series switching determination line used as a determination criterion is selected from any of the series switching determination line L3 of when the engine is operating, the series switching determination line L4 of when the engine is stopped, and the series switching determination line L5 of when the engine is stopped and is at a low temperature.

For example, it is assumed that the required driving force is maintained as indicated by an arrow X1 at a time point of an operating point P1 illustrated in FIG. 10. Note that a tip position of the arrow X1 indicates the required driving force after the time TR from the time point of the operating point P1. Then, when the hybrid vehicle 1 is electrically traveling, for example, the series switching determination line L4 of when the engine is stopped in which line the required driving force after the time TR from the time point of the operating point P1 does not exceed the maximum driving force line L2 is selected.

In such a manner, in the first example, the plurality of series switching determination lines is set according to states of the engine 2, and the HVECU 8 selects different series switching determination lines when the engine is operating and when the engine is stopped. Then, the series switching determination line L4 selected when the engine is stopped is set in such a manner that the battery 6 and the power generation device 91 can be switched to the series connection at a time point at which driving force is small at the same vehicle speed compared to the series switching determination line L3 selected when the engine is operating. As a result, it is possible to supply electric power from the battery 6 and the power generation device 91 connected in series to the drive device 92 while controlling a response delay due to engine starting time. Also, when the engine is stopped, the HVECU 8 selects different series switching determination lines when the engine 2 is at a low temperature lower than a predetermined temperature and when the engine is not at the low temperature. Then, when the engine is stopped, the series switching determination line L5 selected when the engine is at the low temperature is set in such a manner that the battery 6 and the power generation device 91 can be switched to the series connection at a time point at which driving force is small at the same vehicle speed compared to the series switching determination line L4 selected when the engine is not at the low temperature. As a result, it is possible to supply electric power from the battery 6 and the power generation device 91 connected in series to the drive device 92 while controlling a response delay due to time necessary for starting the engine when an engine temperature is low.

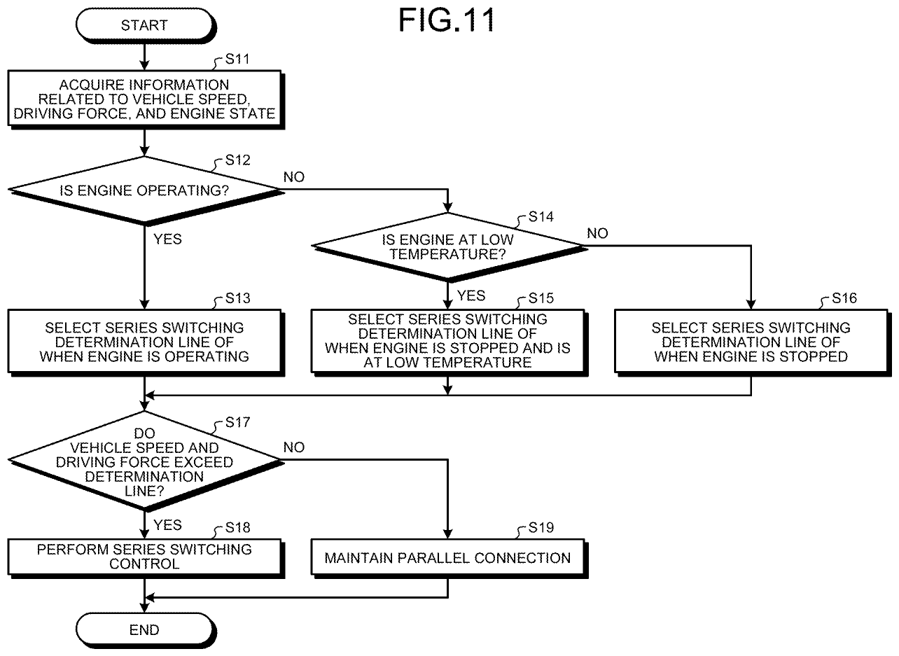

FIG. 11 is a flowchart illustrating an example of switching control of performing switching between the parallel connection and the series connection of the battery 6 and the power generation device 91 in the first example. Note that it is assumed that the switching control illustrated in FIG. 11 is started from a state in which the battery 6 and the power generation device 91 are connected in parallel.

First, the HVECU 8 acquires information related to a vehicle speed, driving force, and an engine state from signals input from various sensors (Step S11). Then, the HVECU 8 determines whether the engine is operating from the acquired information (Step S12). In a case of determining that the engine is operating (Yes in Step S12), the HVECU 8 selects the series switching determination line L3 of when the engine is operating (Step S13).

Also, in a case of determining in Step S12 that the engine is not operating (engine 2 is stopped) (No in Step S12), the HVECU 8 determines whether the engine 2 is at a low temperature from the acquired information (Step S14). Note that a water temperature or the like in the engine 2 is used to determine whether the engine 2 is at the low temperature, for example. In a case of determining that the engine 2 is at the low temperature (Yes in Step S14), the HVECU 8 selects the series switching determination line L5 of when the engine is stopped and is at a low temperature (Step S15).

Also, in a case of determining in Step S14 that the engine 2 is not at the low temperature (No in Step S14), the HVECU 8 selects the series switching determination line L4 of when the engine is stopped (Step S16).

Then, the HVECU 8 determines whether the vehicle speed and the driving force exceed the series switching determination line selected in Step S13, Step S15, or Step S16 (Step S17). In a case of determining that the vehicle speed and the driving force exceed the selected series switching determination line (Yes in Step S17), the HVECU 8 performs series switching control, switches the battery 6 and the power generation device 91 to the series connection by the switching device 7 (Step S18), and ends the series of control. On the one hand, in a case of determining that the vehicle speed and the driving force do not exceed the selected series switching determination line (No in Step S17), the HVECU 8 maintains the parallel connection between the battery 6 and the power generation device 91 (Step S19), and ends the series of control.

In the first example, when the hybrid vehicle 1 is traveling, it is possible to effectively perform switching between the parallel connection and the series connection of the battery 6 and the power generation device 91 by appropriate series switching determination, and to effectively acquire driving force output from the drive motor MG2 with respect to required driving force.

### Second Example

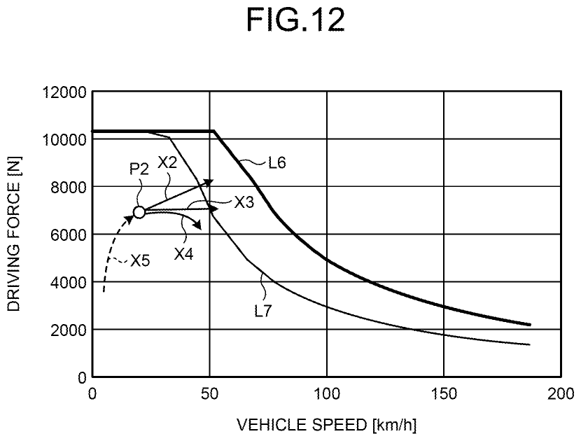

FIG. 12 is a view for describing a predetermined condition for a combination of a vehicle speed and driving force in the second example. Note that L6 in FIG. 12 indicates a maximum driving force line indicating, with respect to a vehicle speed, maximum driving force that can be output by the drive motor MG2 when the battery 6 and the power generation device 91 are connected in series. Also, L7 in FIG. 12 indicates a maximum driving force line indicating, with respect to a vehicle speed, maximum driving force that can be output by the drive motor MG2 when the battery 6 and the power generation device 91 are connected in parallel.

In the second example, a case where the predetermined condition for the combination of the vehicle speed and the driving force is satisfied is a case where required driving force for a vehicle speed after predetermined time exceeds the maximum driving force that can be output by the drive motor MG2 when the battery 6 and the power generation device 91 are connected in parallel. For example, transition of the required driving force for the vehicle speed is predicted with predicted time T, which is acquired by prediction of time from when switching of the battery 6 and the power generation device 91 to the series connection is started until it becomes possible to supply electric power to the drive device 92 from the battery 6 and the power generation device 91 in series connection, as the predetermined time. Then, when the required driving force for the vehicle speed after the predicted time T is likely to exceed the maximum driving force that can be output by the drive motor MG2 in the parallel connection (maximum driving force line L7 in FIG. 12), series switching control to switch the battery 6 and the power generation device 91 to the series connection is performed.

For example, at a time point of an operating point P2 illustrated in FIG. 12, there are a case where the required driving force is increased as the vehicle speed is increased as indicated by an arrow X2 in FIG. 12, a case where the required driving force is maintained even when the vehicle speed is increased as indicated by an arrow X3 in FIG. 12, a case where the required driving force is gradually decreased as the vehicle speed is increased as indicated by an arrow X4 in FIG. 12 and the like. Note that each of tip positions of the arrows X2, X3, and X4 indicates required driving force for the vehicle speed after the predicted time T.

Then, while the hybrid vehicle 1 is electrically traveling, when movement of the required driving force which movement is indicated by the arrows X2 and X3 and in which movement the required driving force for the vehicle speed after the predicted time T exceeds the maximum driving force line L7 is predicted at the time point of the operating point P2, it is possible to perform switching to the series connection between the battery 6 and the power generation device 91, start the engine 2, and perform power generation by the power generation motor MG1, and to effectively acquire driving force output from the drive motor MG2 with respect to the required driving force. On the one hand, while the hybrid vehicle 1 is electrically traveling, when movement of the required driving force which movement is indicated by the arrow X4 and in which movement the required driving force for the vehicle speed after the predicted time T does not exceed the maximum driving force line L7 is predicted at the time point of the operating point P2, switching to the series connection between the battery 6 and the power generation device 91 is not necessary. Thus, it is possible to control unnecessary start of the engine 2 and to improve fuel efficiency.

As a method of predicting transition of required driving force, for example, movement of the required driving force for the vehicle speed which movement is indicated by the arrow X4 is predicted on the assumption that transition of the required driving force for the vehicle speed in the past which transition is indicated by the arrow X5 is kept in FIG. 12. Note that as another method of predicting transition of required driving force, for example, a driving history or the like of a driver may be machine-learned and transition of required driving force for a vehicle speed may be predicted by artificial intelligence.

Also, in the second example, the predicted time T is determined according to time required for the series switching control. That is, when the engine is operating, the predicted time T is only time T1 necessary for switching of the battery 6 and the power generation device 91 from the parallel connection to the series connection, and the predicted time T=time required for the series switching control of when the engine is operating (T1). On the one hand, when the engine is stopped, the predicted time T is time that is the sum of the time T1 and time T2 necessary to start the engine 2 (T1+T2), and the predicted time T=time required for the series switching control of when the engine is stopped (T1+T2). Also, when the engine is stopped and the engine is at a low temperature, the predicted time T is time that is the sum of the time T1 and time T3 (>T2) necessary to start the engine 2 when the engine is at the low temperature (T1+T3), and the predicted time T=time required for the series switching control of when the engine is stopped and is at the low temperature (T1+T3).

In such a manner, in the second example, a plurality of kinds of predicted time T is set according to states of the engine 2, and the HVECU 8 selects different kinds of predicted time T when the engine is operating and when the engine is stopped. Then, predicted time T selected when the engine is stopped is longer than predicted time T selected when the engine is operating. As a result, it is possible to supply electric power from the battery 6 and the power generation device 91 connected in series to the drive device 92 while controlling a response delay due to engine starting time. Also, when the engine is stopped, the HVECU 8 selects different kinds of predicted time T when the engine 2 is at a low temperature lower than a predetermined temperature and when the engine is not at the low temperature. Then, when the engine is stopped, predicted time T selected when the engine is at the low temperature is longer than predicted time selected when the engine is not at the low temperature. As a result, it is possible to supply electric power from the battery 6 and the power generation device 91 connected in series to the drive device 92 while controlling a response delay due to time necessary for starting the engine 2 when the engine is at the low temperature.

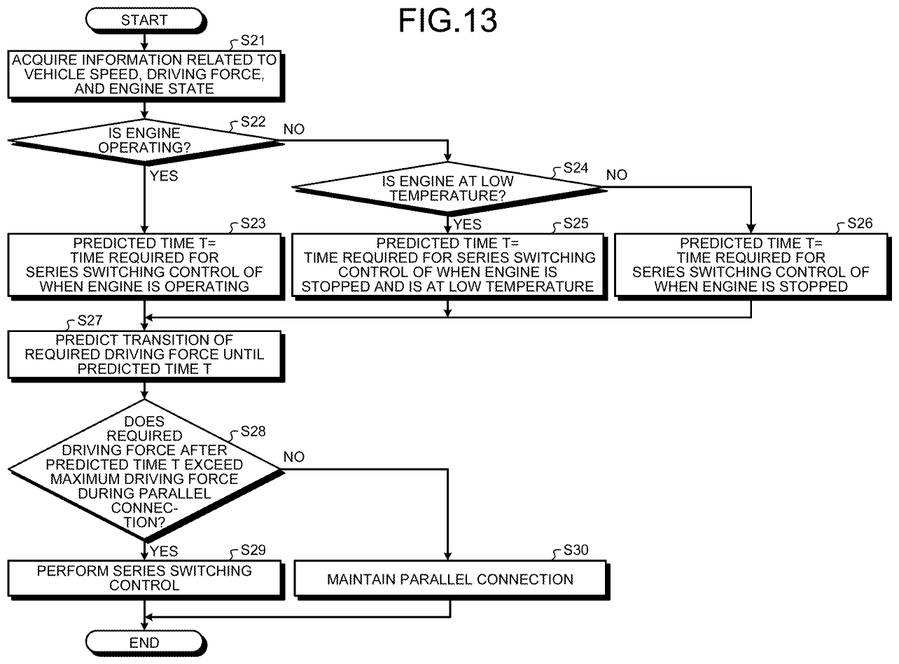

FIG. 13 is a flowchart illustrating an example of switching control of performing switching between the parallel connection and the series connection of the battery 6 and the power generation device 91 in the second example. Note that it is assumed that the switching control illustrated in FIG. 13 is started from a state in which the battery 6 and the power generation device 91 are connected in parallel.

First, the HVECU 8 acquires information related to a vehicle speed, driving force, and an engine state from signals input from various sensors (Step S21). Then, the HVECU 8 determines whether the engine is operating from the acquired information (Step S22). In a case of determining that the engine is operating (Yes in Step S22), the HVECU 8 sets predicted time T=time required for series switching control of when the engine is operating (Step S23).

Also, in Step S22, in a case of determining that the engine is not operating (engine 2 is stopped) (No in Step S22), the HVECU 8 determines whether the engine 2 is at a low temperature from the acquired information (Step S24). Note that a water temperature or the like in the engine 2 is used to determine whether the engine 2 is at the low temperature, for example. In a case of determining that the engine 2 is at the low temperature (Yes in Step S24), the HVECU 8 sets predicted time T=time required for series switching control of when the engine is stopped and is at the low temperature (Step S25).

Also, in a case of determining in Step S24 that the engine 2 is not at the low temperature (No in Step S24), the HVECU 8 sets predicted time T=time required for series switching control of when the engine is stopped (Step S26).

Next, after determining the predicted time T in Step S23, Step S25, or Step S26, the HVECU 8 predicts transition of required driving force until the predicted time T (Step S27). Then, the HVECU 8 determines whether the required driving force after the predicted time T exceeds maximum driving force that can be output from the drive motor MG2 when the battery 6 and the power generation device 91 are connected in parallel (Step S28). In a case of determining that the required driving force after the predicted time T exceeds the maximum driving force (Yes in Step S28), the HVECU 8 performs series switching control, switches the battery 6 and the power generation device 91 to the series connection by the switching device 7 (Step S29), and ends the series of control. On the one hand, in a case of determining that the required driving force after the predicted time T does not exceed the maximum driving force (No in Step S28), the HVECU 8 maintains the parallel connection between the battery 6 and the power generation device 91 (Step S30), and ends the series of control.

In the second example, when the hybrid vehicle 1 is traveling, it is possible to predict transition of a vehicle speed and required driving force until predicted time T and to effectively perform switching between parallel connection and series connection of the battery 6 and the power generation device 91. Thus, it is possible to effectively acquire driving force output from the drive motor MG2 with respect to the required driving force.

In the hybrid vehicle according to the present disclosure, the electric storage device and the power generation device are switched from the parallel connection to the series connection in a case where a combination of a vehicle speed and driving force satisfies a predetermined condition while the vehicle is traveling. Thus, in the hybrid vehicle according to the present disclosure, it is possible to effectively perform switching between the parallel connection and the series connection of the electric storage device and the power generation device at appropriate timing while the vehicle is traveling not only when the engine is operating but also when the engine is stopped.

According to an embodiment, in the hybrid vehicle according to the present disclosure, the electric storage device and the power generation device are switched from the parallel connection to the series connection in a case where a combination of a vehicle speed and driving force satisfies a predetermined condition while the vehicle is traveling. Thus, in the hybrid vehicle according to the present disclosure, it is possible to effectively perform switching between the parallel connection and the series connection of the electric storage device and the power generation device at appropriate timing while the vehicle is traveling not only when the engine is operating but also when the engine is stopped.

According to an embodiment, series switching determination can be made on the basis of a current vehicle speed and driving force, and the electric storage device and the power generation device can be switched to the series connection at appropriate timing while the vehicle is traveling.

According to an embodiment, it becomes possible to supply electric power to the drive device from the electric storage device and the power generation device connected in series while controlling a response delay due to engine starting time.

According to an embodiment, it becomes possible to supply electric power from the electric storage device and the power generation device connected in series to the drive device while controlling a response delay due to time necessary for starting the engine when the engine is at a low temperature.

According to an embodiment, the electric storage device and the power generation device can be switched to the series connection at appropriate timing while the vehicle is traveling. Also, in a case where required driving force with respect to a vehicle speed after a predetermined time does not exceed the maximum driving force, an unnecessary start of the engine can be controlled and fuel efficiency can be improved.

According to an embodiment, it becomes possible to supply electric power from the electric storage device and the power generation device connected in series to the drive device while controlling a response delay due to time necessary before it becomes possible to supply the electric power to the drive device from the electric storage device and the power generation device in the series connection.

According to an embodiment, it becomes possible to supply electric power to the drive device from the electric storage device and the power generation device connected in series while controlling a response delay due to engine starting time.

According to an embodiment, it becomes possible to supply electric power from the electric storage device and the power generation device connected in series to the drive device while controlling a response delay due to time necessary for starting the engine when the engine is at a low temperature.

Although the disclosure has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A hybrid vehicle comprising:
a power generation device including an engine, a first rotating electric machine capable of generating electric power by using power from the engine, and a first inverter capable of converting an AC voltage and a DC voltage with the first rotating electric machine;
a drive device including a second rotating electric machine that outputs a driving force to drive a drive wheel, and a second inverter capable of converting an AC voltage and a DC voltage with the second rotating electric machine;
an electric storage device that exchanges electric power with the power generation device and the drive device;
a switching device that switches electrical connection of the electric storage device and the power generation device between parallel connection and series connection with respect to the drive device; and
a control device that at least controls the switching device, wherein
the control device controls the switching device in such a manner as to switch the electric storage device and the power generation device from the parallel connection to the series connection in a case where a combination of a vehicle speed and the driving force satisfies a predetermined condition while the hybrid vehicle is traveling.

2. The hybrid vehicle according to claim 1, wherein the predetermined condition is satisfied when a current vehicle speed and driving force exceed a series switching determination line that indicates a relationship between the vehicle speed and the driving force and that is a determination criterion for switching the electric storage device and the power generation device to the series connection.

3. The hybrid vehicle according to claim 2, wherein a plurality of the series switching determination lines is set according to a state of the engine,
the control device selects different series switching determination lines depending on whether the engine is operating or the engine is stopped, and
the series switching determination line selected when the engine is stopped is set in such a manner that the electric storage device and the power generation device can be switched to the series connection at a time point at which the driving force is small at a same vehicle speed compared to the series switching determination line selected when the engine is operating.

4. The hybrid vehicle according to claim 3, wherein, when the engine is stopped, the control device selects different series switching determination lines depending on whether the engine is at a low temperature lower than a predetermined temperature or the engine is not at the low temperature, and
the series switching determination line selected when the engine is at the low temperature is set in such a manner that the electric storage device and the power generation device can be switched to the series connection at a time point at which the driving force is small at the same vehicle speed compared to the series switching determination line selected when the engine is not at the low temperature.

5. The hybrid vehicle according to claim 1, wherein the predetermined condition is satisfied when required driving force for a vehicle speed after a predetermined time exceeds maximum driving force that can be output by the second rotating electric machine when the electric storage device and the power generation device are connected in parallel.

6. The hybrid vehicle according to claim 5, wherein the predetermined time is predicted time acquired by prediction of time from when switching of the electric storage device and the power generation device to the series connection is started until it becomes possible to supply electric power to the drive device from the electric storage device and the power generation device in the series connection.

7. The hybrid vehicle according to claim 6, wherein a plurality of kinds of the predicted time is set according to a state of the engine,
the control device selects different kinds of the predicted time depending whether the engine is operating or the engine is stopped, and
the predicted time selected when the engine is stopped is longer than the predicted time selected when the engine is operating.

8. The hybrid vehicle according to claim 7, wherein, when the engine is stopped, the control device selects different kinds of the predicted time when the engine is at a low temperature that is lower than a predetermined temperature and when the engine is not at the low temperature, and
the predicted time selected when the engine is at the low temperature is longer than the predicted time selected when the engine is not at the low temperature.
